(19) United States
(12) Patent Application Publication
(10) Pub. No.: US 2025/0092774 A1
(43) Pub. Date: Mar. 20, 2025

(54) SYSTEM AND METHODS FOR DETERMINING GEL BREAKING TIME OF THIXOTROPIC DRILLING FLUIDS

(71) Applicant: Baker Hughes Oilfield Operations LLC, Houston, TX (US)

(72) Inventors: SYED EHSANUR RAHMAN, Conroe, TX (US); ROGER ARAGALL, Celle (DE); REZA ETTEHADI OSGOUEI, Spring, TX (US); ROLAND MAY, Celle (DE); CHARLES THOMPSON, Kingwood, TX (US); ALEXA MORGAN MILSTEIN, Houston, TX (US)

(73) Assignee: Baker Hughes Oilfield Operations LLC, Houston, TX (US)

(21) Appl. No.: 18/369,175

(22) Filed: Sep. 17, 2023

(51) Int. Cl. E21B 44/00; E21B 21/00

(52) U.S. Cl. CPC E21B 44/00; E21B 21/00; E21B 21/08; G01N 11/00; E21B 2200/20

(57) ABSTRACT

The behavior of gelled drilling fluids can be predicted with a low number of input parameters using an empirically derived equation that expresses the breakage of gelled drilling fluids as a function of the total strain applied to the gelled drilling fluids. Using correlative systems and lab-scale experiments, a predictive model correlates the various test input parameters with an anticipated time for breaking the gelled drilling fluid under known strain rate. Applying actual input parameters to the predictive model for a given well drilling operation produces a prescribed gel breaking procedure. The systems and methods disclosed herein provide an operator with accurate predictions of the time necessary to break a given gelled drilling fluid. The models and methods disclosed herein can be incorporated into a control system so the drilling rig can automatically adjust its operation to most effectively break the gelled drilling fluid following a pump-off event.

### FIELD OF THE INVENTION

The present application is generally directed at drilling fluids and more particularly, but not by way of limitation, to systems and methods for more accurately determining the time necessary to break a gelled drilling fluid.

### BACKGROUND OF THE INVENTION

Drilling fluids serve various functions in the well construction process, including transporting drill cuttings, balancing formation pressures, and stabilizing the wellbore prior to insertion of the casing. Because each drilling project and formation presents unique requirements, the rheological properties of each fluid are carefully designed and adjusted to meet those specifications. For example, a given drilling fluid may be designed to remove drill cuttings by preventing their precipitation and to incorporate different chemical additives that also lubricate, form a desirable filter cake, deflocculate, and control fluid loss.

When the fluid pumps are not operational, i.e., during a “pump-off” event, the absence of shear causes some drilling fluids to form a viscous, gelled structure due to the intricate fluid compositions and the presence of solids dispersed in the drilling fluid. The gelled structure can be beneficial because it tends to prevent drill cuttings from falling and accumulating in lower portions of the well while the drilling fluid is not circulating through the well. To facilitate pumping of the gelled fluid after the termination of pump-off conditions, drilling fluids are designed with rheological properties that exhibit shear thinning behavior in which the viscosity decreases as the fluid velocity increases. Most modern drilling fluids therefore possess thixotropic and shear-dependent characteristics.

Notwithstanding the significant advances in the formulation of modern drilling fluids, there are no widely accepted methods for reliably determining the time required to break the gelled structure of the stagnant drilling fluid. The amount of pump pressure that should be applied to the gelled fluid and the time necessary to “break the gel” are both estimated by an operator, who relies on personal experience to inform decisions about how much pump pressure and pump operation time are appropriate for a given gelled drilling fluid. This reliance on an operator's subjective input presents numerous risks and frustrates attempts for the adoption of standardized methodology.

In particular, understanding gel strength and gel breaking time is critical to avoid over-pressurizing or under-pressurizing a system. When pumping of a drilling fluid begins after a period of static conditions, a surge pressure can occur within the wellbore due to time-dependent and shear-dependent behavior of the static, gelled fluid. This surge pressure may not be particularly detrimental if there is a large difference between the pore pressure and fracture gradient of the well being drilled. However, in narrow operating windows, which are often encountered in offshore and managed pressure drilling (MPD) applications, it becomes important to avoid pressure surges that could damage the wellbore or create lost circulation problems. Further, because downhole conditions (e.g., depth, temperature, flow rate, gel time, cuttings ratio) are continually changing, the protections for these pump operations must be continually updated.

It is, therefore, desirable to have a system and method for accurately and objectively predicting the optimal conditions for breaking a gelled drilling fluid. A need exists for a predictive model that characterizes the rheological behavior of specific drilling fluids and permits a reliable determination of the strain and time necessary for gel breaking for various drilling fluids. The present disclosure is directed at these and other deficiencies in the prior art.

### SUMMARY OF THE INVENTION

In some embodiments, the present disclosure is directed at systems and methods for using a drilling rig to break a drilling fluid that has gelled in a wellbore. The method includes the steps of developing a predictive gel breaking model that predicts the total strain required to break the gelled drilling fluid, applying one or more input parameters to the predictive gel breaking model to obtain a prescribed gel breaking procedure, and operating the drilling rig according to the prescribed gel breaking procedure to break the gelled drilling fluid.

### BRIEF DESCRIPTION OF THE DRAWINGS

The above and other objects and advantages of this invention may be more clearly seen when viewed in conjunction with the accompanying drawings, which are not drawn to scale, wherein:

FIG. 1 depicts a simplified drilling rig in the process of drilling a wellbore.

FIG. 2 is a process flow diagram for a method of developing a predictive gel breaking model.

FIG. 3 depicts a graph of shear stress over time (i.e., a stress curve) used during the development of the gel breaking model of FIG. 2.

FIG. 4 is a process flow diagram for a method of breaking a gelled drilling fluid using the predictive model developed according to the method in FIG. 2.

### DETAILED DESCRIPTION

According to exemplary embodiments, it has been discovered that the behavior of gelled drilling fluids can be predicted with a low number of input parameters using an empirically derived equation that expresses the breakage of gelled drilling fluids as a function of the total strain applied to the gelled drilling fluids. Using machine learning or other correlative systems and lab-scale experiments, a predictive model is determined that correlates the various test input parameters with an anticipated time for breaking the gelled drilling fluid under known strain rate and other operational conditions. Applying actual input parameters to the predictive model for a given well drilling operation produces a prescribed gel breaking procedure under strain conditions that are known or established for a given drilling operation and drilling fluid. In this way, the systems and methods disclosed herein provide an operator with accurate predictions of the time necessary to break a given gelled drilling fluid. In some embodiments, the systems and methods disclosed herein are incorporated into one or more control systems for the drilling rig so that the drilling rig can automatically adjust its operation to most effectively break the gelled drilling fluid following a pump-off event.

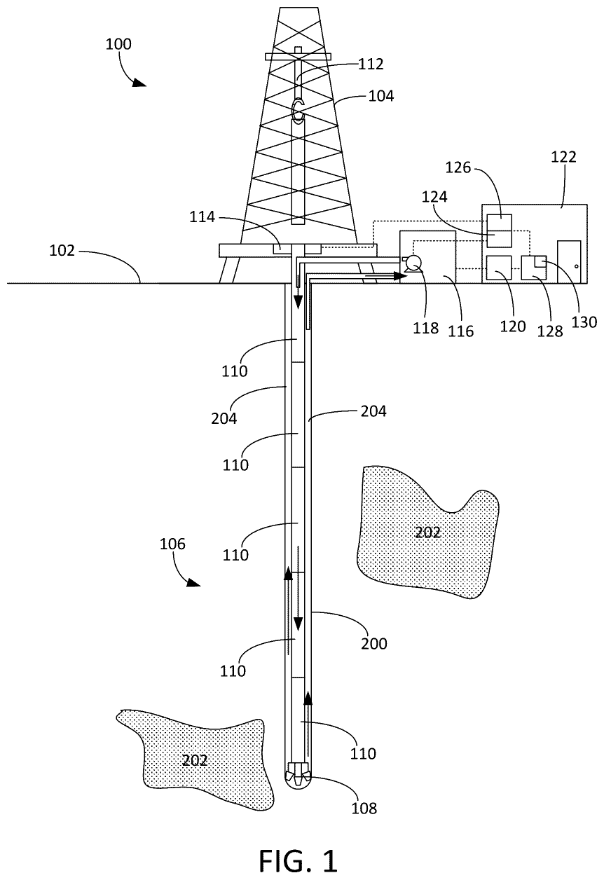

Turning to FIG. 1, shown therein is a depiction of a drilling rig 100 that is in the process of drilling a wellbore 200 for the production of petroleum products, water, brine, or other resources found in subterranean formations 202. The drilling rig 100 is located on a surface 102, which can be an onshore well pad or an offshore drilling platform. Although the wellbore 200 is depicted as a conventional vertical wellbore, it will be appreciated that the drilling rig 100 and the systems and methods disclosed herein can also be used for drilling deviated, horizontal and other non-vertical wells.

The drilling rig 100 includes a derrick 104 supported by the surface 102, and a drill string 106 supported by the derrick 104. The drill string 106 includes a drill bit 108 connected to one or more segments of drill pipe 110. In accordance with well-established drilling practices, the drill string 106 and drill bit 108 are lowered into the wellbore 200 by a hoist system 112. A rotary table 114 is used to rotate the drill string 106. It will be appreciated that, in other embodiments, a top drive may alternatively be used to rotate the drill string 106.

The drilling rig includes a mud circulation system 116 that controls the flow of drilling fluids or drilling muds into the wellbore 200 through the drill string 106. In most cases, the mud circulation system 116 pumps clean drilling fluids through the drill string 106 and drill bit 108, where the drilling fluid is discharged into the wellbore 200 and carried to the surface 102 through an annular space 204 between the wall of the wellbore 200 and the drill string 106. The drilling fluid carries cuttings and other debris out of the wellbore 200 to the mud circulation system 116 through the annular space 204. The mud circulation system 116 cleans the drilling fluid and recirculates the drilling fluid back into the wellbore 200.

The mud circulation system 116 includes one or more mud pumps 118 and one or more mud analyzers 120. The mud pumps 118 are used to pump the drilling fluid into the drill string 106. The mud analyzers 120 provide live information about the state of the drilling fluid, including its weight (density), viscosity, temperature, and concentration of solid particles. It will be appreciated that the mud circulation system 116 includes other components, such as mud pits, tanks and vibrating shaker screens (not separately shown).

The density of the drilling fluid is continuously monitored according to the immediate requirements of the drilling operation and provided with additives that improve the performance of the drilling fluid. In exemplary embodiments, the drilling fluids contemplated for use by the drilling rig 100 are thixotropic such that the viscosity of the drilling fluid is inversely proportional to the strain applied to the drilling fluid. Accordingly, during a “pump off” event when the mud circulation system 116 is not pumping the drilling fluid through the wellbore 200, the viscosity of the drilling fluid generally increases to form a gelled drilling fluid. As noted above, the gelled drilling fluid can be beneficial because it prevents cuttings and debris from falling and accumulating at the bottom of the wellbore 200, while also providing lateral support to the uncased walls of the wellbore 200.

The drilling rig 100 includes a control system 122 that can be located on or near the derrick 104. The control system 122 includes a series of computer-enabled systems for directly or indirectly controlling the operation of the drilling rig 100. In exemplary embodiments, the control system 122 is an integrated control system that allows an operation to control the operation of a number of the systems within the drilling rig 100, including the rotary table 114 and the mud pumps 118. In this way, the control system 122 includes a mud pump control module 124 and a rotary table control module 126, which are configured to control the operation of the mud pumps 118 and rotary table 114, respectively. It will be appreciated that the mud pump control module 124, the rotary table control module 126 and other features of the control system 122 can be consolidated into a computer-enabled integrated controller 128 or a plurality of separate by controllers networked together.

The integrated controller 128 receives inputs from sensors throughout the drilling rig 100, including the mud analyzer 120, the mud pumps 118 and the rotary table 114. In response to those inputs, the integrated controller 128 controls the operation of the rotary table 114, mud pumps 118 and other systems within the drilling rig 100. In particular, the integrated controller 128 includes a computer-implemented gel breaking model 130 that can be used with inputs from one or more of the mud analyzer 120, the mud pump control module 124 and the rotary table control module 126 to determine the amount of time it will take to break the gelled drilling fluids in the wellbore 200 and drill string 106 following a period in which the drilling fluid is static or stagnant.

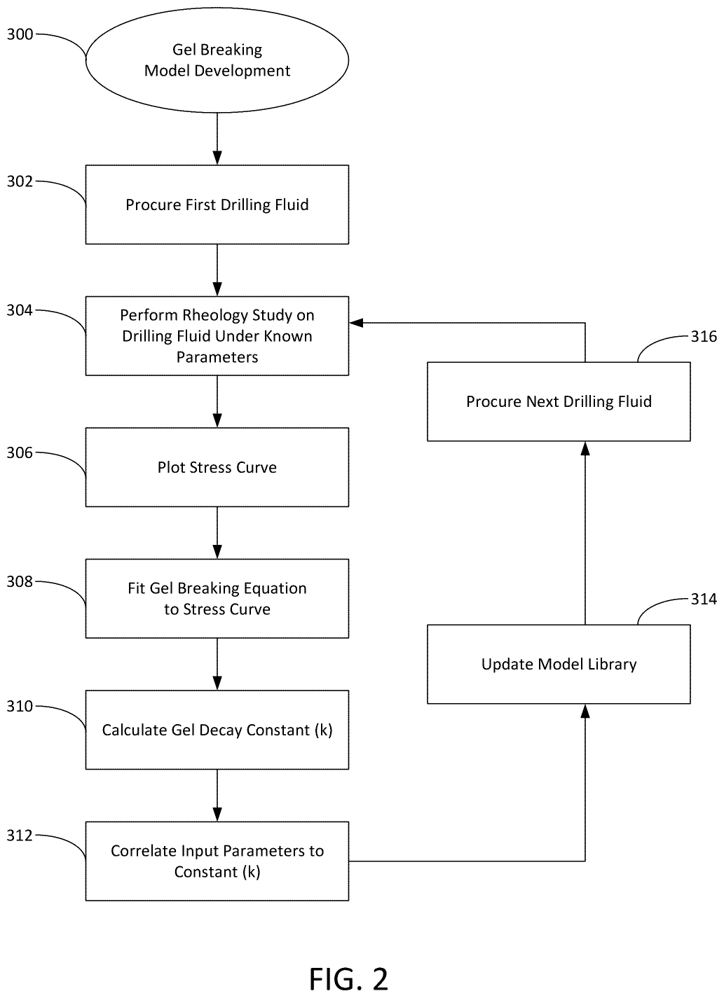

Turning to FIG. 2, shown therein is a process flow diagram for a method 300 for developing the gel breaking model 130. It will be appreciated that in exemplary embodiments, the method 300 takes place in a laboratory environment before the gel breaking model 130 is deployed for use in connection with the drilling rig 100.

The method 300 starts at step 302 when a sample of a first drilling fluid is obtained for testing. The drilling fluid has known quantitative and qualitative characteristics, which may include, for example, chemical formulation, weight (density), temperature, total dissolved solids (TDS) for low gravity and high gravity solids, salinity and oil-water-solids ratios. At step 304, the first drilling fluid undergoes a battery of rheology tests using a high precision rheometer, such as an air bearing rheometer. The rheology tests are designed to determine the conditions that are required to break the drilling fluid once it has gelled after one or more periods of time, e.g., a gelled structure resulting from 10 seconds of stagnation, a gelled structure resulting from 10 minutes of stagnation, or a gelled structure resulting from 30 minutes of stagnation.

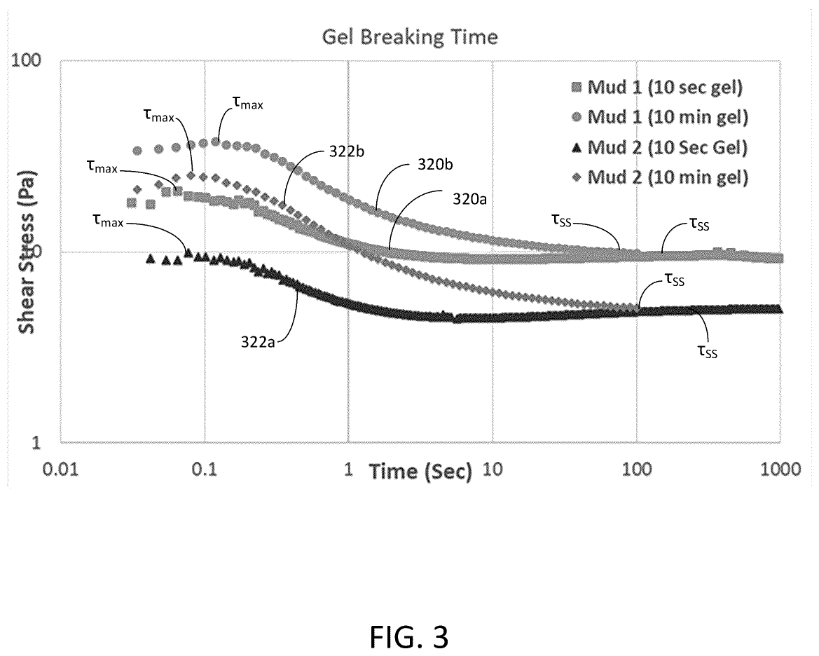

At step 306, shear stress curves are plotted from the results of the rheology tests conducted on the first drilling fluid. FIG. 3 depicts sample shear stress curves 320, 322 for two drilling fluids plotted over time for both 10 second gels (320a, 322a) and 10 minute gels (320b, 322b). The shear stress curves 320, 322 illustrate two important features related to the breakdown of the gelled drilling fluids. At the beginning of the tests, the shear stress (τ) rises and peaks before it begins to decrease. The peak (τₘₐₓ) of the shear stress curves approximately indicates the initialization of gel breaking. When the shear stress (τ) stabilizes at a steady state value (τ_{SS}), the gelled structure of the drilling fluid has been substantially broken such that further application of strain to the drilling fluid will not substantially change its viscosity. The shear stress curves can be used to calculate total strain.

Importantly, determining the total strain required to break the gelled drilling fluids provides the basis for later calculating the anticipated time to break the gelled drilling fluid at known strain rates. The total strain required to break the drilling fluid can be determined by finding the integral of the strain rate over the period required to break the gelled drilling fluid. One or more equations can be fit to the shear stress curves plotted at step 306 and used as the basis for calculating the total strain required to break the gelled drilling fluids.

Thus, in some embodiments, the method 300 moves to step 308 where an equation is fitted to the shear stress curves plotted at step 306. One such suitable equation is presented below:

$$τ ( {t}_{s} ) = {τ}_{ss} + {Δ}_{max} {e}^{- \frac{1}{k} {\int }_{0}^{{t}_{s}} \dot{γ} ( {r}_{s} ) dt}$$

where τ(tₛ) represents shear stress at a given time (tₛ), τ_{SS} represents the baseline steady-state stress, Δₘₐₓ represents the difference between the gelled-state stress for the drilling fluid and the baseline steady-state stress for the drilling fluid, k represents the gel decay constant, and the integral ∫₀^{t}^{ₛ}\dot{γ}(tₛ)dt represents the total strain (or work) imparted to the drilling fluid during the gel breaking procedure. By fitting this equation to the shear stress curves produced at step 306, a value for the gel decay constant (k) can be determined at step 310 using MatLab or other analytical software with curve-fitting functionality.

The gel decay constant (k) may account for a number of different parameters for the drilling fluid. At step 312, the gel decay constant (k) is correlated with the various input characteristics for the drilling fluid under examination. For example, the gel decay constant (k) can be associated with the formulation chemistry, initial gel strength, and the rate at which the gelled structure of the drilling fluid broke down in the presence of a known strain.

At step 314, the predictive gel breaking model 130 is updated with the gel decay constant (k) for the selected drilling fluid and the parameters associated with the test of the drilling fluid. At step 316, another drilling fluid is selected for evaluation using the process outlined above. Over multiple tests and iterations, machine learning or other correlative techniques can be used to associate the gel decay constant (k) with one or more parameters associated with the drilling fluids. Ultimately, the gel breaking model 130 will include a library of drilling fluids and relevant parameters related to those drilling fluids that is either directly correlated from experimental results with a gel decay constant (k) or for which a gel decay constant (k) can be approximated or predicted using machine learning and the database of past experimental results.

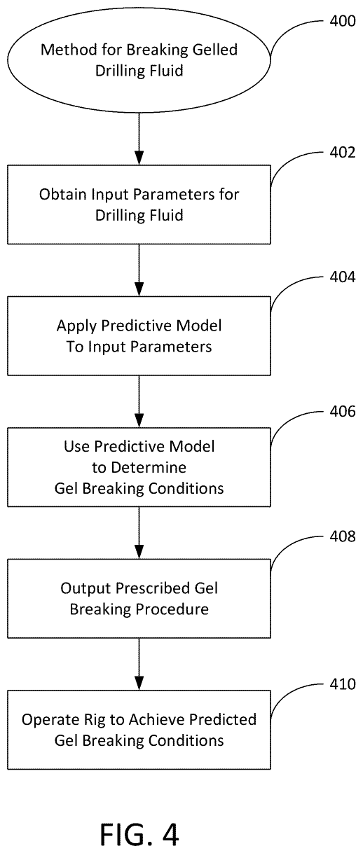

Turning to FIG. 4, shown therein is a method 400 for breaking a gelled drilling fluid using the predictive gel breaking model 130, which can be installed as part of a computer-implemented control program within the integrated controller 128 at the drilling rig 100. Some or all of the predictive gel breaking model 130 can be stored in remote computers and accessed by the integrated controller 128 at the drilling rig 100. As explained below, the method 400 is intended to provide the operator with guidance on how to most effectively break a drilling fluid that has gelled in the wellbore 200 and drill string 106. In some embodiments, the method 400 includes the automated or semi-automated control of the mud pump control module 124 and the rotary table control module 126 based on the determinations made by the gel breaking model 130.

The method 400 begins with the step of obtaining various input parameters for the gelled drilling fluid. The parameters for the gelled drilling fluid can be presented to the integrated controller 128 by the mud analyzer 120 and from product literature associated with the particular drilling fluid present in the wellbore 200. The input parameters describe various rheological and non-rheological properties of the drilling fluid including, but not limited to, weight (density), initial gel strength, chemical formulation, viscosity measurements, salt concentration, viscosity, temperature, and pressure. In some embodiments, the input parameters also include gel strength after ten (10) minutes, volume percent of oil, volume percent of water, volume percent of solids, volume percent of low gravity solids, volume percent of high gravity solids, oil-to-water ratio, weight (wt.) % salt (e.g., CaCl₂), KCl, NaCl), rheology at 600 rpm, rheology at 300 rpm, rheology at 200 rpm, rheology at 100 rpm, rheology at 6 rpm, rheology at 3 rpm, temperature for viscometer readings (such as those readings obtained from a Fann® Model 35 Viscometer or other suitable viscometer), sample temperature, and pressure. The measurements for the various input parameters can be acquired from the mud analyzer 120 and other sensors and measurement devices on the drilling rig.

At step 404, the various input parameters are provided to the integrated controller 128 and used by the predictive gel breaking model 130 at step 406 to determine the prescribed amount of gel breaking strain or prescribed gel breaking time at a known rate of strain that will be required to successfully break the gelled structure of the drilling fluid, or both. In making this determination, the integrated controller 128 relies on computer processors to correlate the input parameters with an appropriate gel decay constant (k). The integrated controller 128 can use machine learning or other correlative techniques to identify or calculate an appropriate gel decay constant (k) based on the input parameters. It will be appreciated that certain of the input parameters may be weighed more heavily in determining the appropriate gel decay constant (k). For example, the chemical formulation of the gelled drilling fluid and the initial gel strength of the drilling fluid as determined by viscometers in the mud analyzer 120 may be weighted more heavily in determining the appropriate gel decay constant (k).

Once the appropriate gel decay constant (k) is determined, the integrated controller 128 predicts the total strain (or work) that is required to break the gelled drilling fluid. The predetermined rate of strain imparted on the drilling fluid by the operation of the mud pumps 118 (axial strain) and the rotary table 114 and drill string 106 (rotational strain) at known operational conditions can be used as inputs to determine the prescribed gel breaking time for breaking the gelled drilling fluid at the same or similar operational conditions. The prescribed gel breaking strain and prescribed gel breaking time calculated by the integrated controller 128 can be output by printer or visual display to the operator at step 408.

At step 410, the mud pumps 118, the rotary table 114 or both the mud pumps 118 and the rotary table 114 are activated and operated at speeds, flow rates and times that are intended to match the prescribed gel breaking procedure to satisfactorily break the gelled drilling fluid in the wellbore 200 and drill string 106. In some embodiments, the operator manually adjusts the operation of the mud pumps 118 and rotary table 114 in accordance with the prescribed rates and times recommended by the predictive gel breaking model 130. In other embodiments, the integrated controller 128 directly interfaces with the mud pump control module 124 and rotary table control module 126 at step 410 to impart axial and rotational strain on the gelled drilling fluid in the wellbore 200 and drill string 106. Once the prescribed total strain has been applied to the drilling fluid, the integrated controller 128 can automatically adjust the control of the mud pumps 118 to prevent potentially damaging the wellbore 200 with unnecessary pressure surges.

A result of the foregoing method 400 is that the strain and time necessary to break the gelled drilling fluid are determined using objective data, and this information directly informs the total strain applied by the mud pump 118 and rotary table 114 to the drilling fluid. By stopping or reducing the output of the mud pumps 118 at the end of the prescribed gel breaking time, it is possible to more accurately and safely perform managed drilling operations. Another result of the method 400 is that by operating the mud pumps 118 only at the prescribed output level and time necessary to break the gelled drilling fluid, the risk of exceeding pressure limits and causing damage to the formation is reduced.

In the foregoing specification, the invention has been described with reference to specific embodiments thereof. However, it will be evident that various modifications and changes can be made thereto without departing from the broader scope of the invention as set forth in the appended claims. Accordingly, the specification is to be regarded in an illustrative rather than a restrictive sense. For example, different fluid formulations, drilling fluids, parameters, curves, strains, times, proportions, dosages, and amounts not specifically identified or described in this disclosure or not evaluated are still expected to be within the scope of this invention.

The present invention may suitably comprise, consist of, or consist essentially of the elements disclosed and may be practiced in the absence of an element not disclosed. As used herein, the singular forms “a,” “an,” and “the” are intended to include the plural forms as well, unless the context clearly indicates otherwise. As used herein, the term “about” in reference to a given parameter is inclusive of the stated value and has the meaning dictated by the context (e.g., it includes the degree of error associated with measurement of the given parameter). As used herein, the term “and/or” includes any and all combinations of one or more of the associated listed items.

It is claimed:

1. A method for using a drilling rig to break a drilling fluid that has gelled in a wellbore, the method comprising the steps of:
developing a predictive gel breaking model that predicts the total strain required to break the gelled drilling fluid;
applying one or more input parameters to the predictive gel breaking model to obtain a prescribed gel breaking procedure; and
operating the drilling rig according to the prescribed gel breaking procedure to break the gelled drilling fluid.

2. The method of claim 1, wherein the step of developing the predictive gel breaking model comprises:
performing a rheology test on a fluid formulation to obtain test data, wherein the fluid formulation is characterized by a plurality of test parameters and wherein the fluid formulation is representative of the drilling fluid; and
plotting shear stress curves for the test data.

3. The method of claim 2, wherein the step of developing the predictive gel breaking model further comprises fitting a gel breaking equation to the shear stress curves.

4. The method of claim 3, wherein the gel breaking equation has the form of:
$$τ ( {t}_{s} ) = {τ}_{ss} + {Δ}_{max} {e}^{- \frac{1}{k} {\int }_{0}^{{t}_{s}} \dot{γ} ( {t}_{s} ) dt}$$
where τ(tₛ) represents shear stress at a given time (tₛ), τ_{SS} represents a baseline steady-state stress, Δₘₐₓ represents the difference between a gelled-state stress for the drilling fluid and the baseline steady-state stress for the drilling fluid, k represents a gel decay constant, and the integral ∫₀^{t}^{ₛ}\dot{γ}(tₛ)dt represents a total strain required to break the gelled drilling fluid.

5. The method of claim 4, wherein the step of developing the predictive gel breaking model further comprises correlating the gel decay constant (k) with the plurality of test parameters for the fluid formulation.

6. The method of claim 5, wherein the step of correlating the gel decay constant (k) with the plurality of test parameters further comprises applying machine learning to the plurality of test parameters.

7. The method of claim 6, wherein the step of applying one or more input parameters to the predictive gel breaking model further comprises:
loading the predictive gel breaking model into an integrated controller on the drilling rig; and
applying one or more input parameters obtained from a mud analyzer on the drilling rig to the integrated controller.

8. The method of claim 7, wherein the one or more input parameters comprises a weight of the drilling fluid and an initial strength of the gelled drilling fluid.

9. The method of claim 7, wherein the one or more input parameters are selected from the group consisting of mud weight, initial gel strength, gel strength after ten minutes, volume percent of oil, volume percent of water, volume percent of solids, volume percent of low gravity solids, volume percent of high gravity solids, oil-to-water ratio, wt. % salt, rheology at 600 rpm, rheology at 300 rpm, rheology at 200 rpm, rheology at 100 rpm, rheology at 6 rpm, rheology at 3 rpm, temperature for viscometer readings, sample temperature, and pressure.

10. The method of claim 7, wherein the step of operating the drilling rig according to the prescribed gel breaking procedure comprises adjusting the operation of mud pumps for a prescribed period to obtain a total strain required to break the gelled drilling fluid.

11. The method of claim 10, wherein the step of operating the drilling rig according to the prescribed gel breaking procedure comprises automatically adjusting the operation of mud pumps with the integrated controller for a prescribed period to obtain a total strain required to break the gelled drilling fluid.

12. The method of claim 7, wherein the step of operating the drilling rig according to the prescribed gel breaking procedure comprises adjusting the operation of a rotary table for a prescribed period to obtain a total strain required to break the gelled drilling fluid.

13. The method of claim 7, wherein the step of operating the drilling rig according to the prescribed gel breaking procedure comprises automatically adjusting the operation of a rotary table with the integrated controller for a prescribed period to obtain a total strain required to break the gelled drilling fluid.
